(19) United States
(12) Patent Application Publication
(10) Pub. No.: US 2008/0094387 A1
(43) Pub. Date: Apr. 24, 2008

(54) METHOD FOR CONTROLLING POWER AND DISPLAY PARAMETERS OF A MONITOR AND MONITOR FOR THE SAME

(76) Inventor: Min-Jye Chen, Miao-Li City (TW)

Correspondence Address: NORTH AMERICA INTELLECTUAL PROPERTY CORPORATION, P.O. BOX 506, MERRIFIELD, VA, 22116, US

(21) Appl. No.: 11/874,900

(22) Filed: Oct. 18, 2007

(30) Foreign Application Priority Data
Oct. 19, 2006 (TW) 095138616

(51) Int. Cl. G09G 5/00

(52) U.S. Cl. 345/212; 345/204

(57) ABSTRACT

Under the condition of a computer system being powered on, a switch on a monitor controls the power or the display parameters of the monitor according to the triggering time of the switch. When the switch is triggered for more than a predetermined period of time, a control unit of the monitor sets the monitor to the standby state or powers off the monitor. When the switch is triggered for less than the predetermined period of time, the control device then controls the monitor to display video signals from the computer system according to different display parameters.

### BACKGROUND OF THE INVENTION

1. Field of the Invention

The present invention relates to a monitor control method and a monitor, and more specifically, to a method for controlling power and display parameters of a monitor and monitor for the same.

2. Description of the Prior Art

During the development of display technology, monitors that support display data channel/command interface (DDC/CI) have been drawing more and more attention. Unlike traditional monitors whose display parameters are configured only through buttons on the panel, DDC/CI allows a user direct configuration of the display parameters through application programs in the computer system, which the process for configuring the display parameters and the result of the configuration are shown on the monitor. Therefore, a present monitor that supports DDC/CI requires far fewer buttons than a traditional monitor. Only a power button on the panel or even no one at all.

Except for the power button that controls the power of the monitor, all other configurations for display parameters of a prior art monitor with DDC/CI function are done through the application programs in the computer system. Although most buttons on the monitor are abandoned, configuring and applying the display parameters on the monitor is practical only when the monitor displays screen normally. Once the monitor has display abnormities such as over brightness or under brightness, over contrast or under contrast, that lower the readability of the messages on the monitor or for even worse situation, the monitor can not display any recognizable screen, configuring the display parameters through application programs in the computer system is impossible.

On the other hand, for most users, it is a convenient way to switch to different default display parameters through one single button press on the monitor. But a DDC/CI monitor with only one power button on it can scarcely enjoy the convenience. Application configuration to switch to different default display parameters is no doubt inextricable.

### SUMMARY OF THE INVENTION

The present invention provides a method for controlling a monitor, the monitor capable of being selectively set in or out of an operative state, the monitor having a switch and storing a first display parameter and a second display parameter. The method comprises steps of setting the monitor in the operative state for displaying a video signal according to the first display parameter; the monitor displaying the video signal according to the second display parameter when detecting the switch being triggered for less than a predetermined time period; and setting the monitor out of the operative state when detecting the switch being triggered for more than the predetermined time period.

The present invention also provides a method for controlling power and display parameters of a monitor capable of being selectively set in or out of a operative state, the monitor having a switch and storing a first display parameter and an adjustment value. The method comprises steps of setting the monitor in the operative state for displaying a video signal according to the first display parameter; when the monitor detects the switch being triggered for less than a predetermined time period, the monitor generating a second display parameter by adding the adjustment value to the first display parameter and displaying the video signal according to the second display parameter; and setting the monitor out of the operative state when detecting the switch being triggered for more than the predetermined time period.

The present invention also provides a monitor capable of being selectively set in or out of an operative state. The monitor comprises a storage device storing a first display parameter and a second display parameter, the monitor being capable of displaying a video signal selectively according to the first display parameter or to the second display parameter when in the operative state; a switch capable of being selectively triggered; and a control unit electrically coupled with the switch for detecting whether the switch is triggered; wherein when the control unit detects the switch being triggered for less than a predetermined time period, the control unit controls the monitor from displaying the signal according to the first display parameter to displaying the video signal according to the second display parameter; wherein when the control unit detects the switch being triggered for more than the predetermined time period, the control unit sets the monitor out of the operative state.

The present invention also provides a monitor capable of being selectively set in or out of an operative state. The monitor comprises a storage device storing a first display parameter and an adjustment value, the first display parameter being updated by adding the adjustment value to the first display parameter, the monitor being capable of displaying a video signal selectively according to the first display parameter or to the updated first display parameter when in the operative state; a switch capable of being selectively triggered; and a control unit electrically coupled with the switch for detecting whether the switch is triggered; wherein when the control unit detects the switch being triggered for less than a predetermined time period, the control unit controls the monitor from displaying the video signal according to the first display parameter to displaying the video signal according to the updated first display parameter; wherein when the control unit detects the switch being triggered for more than the predetermined time period, the control unit sets the monitor out of the operative state.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of a monitor capable of controlling power and display parameters.

FIG. 2 is an illustration of a flow chart of an exemplary embodiment of the method for controlling power and display parameter of a monitor.

FIG. 3 is an illustration of a flow chart of the method for controlling the power of the monitor when the monitor is turned off.

### DETAILED DESCRIPTION

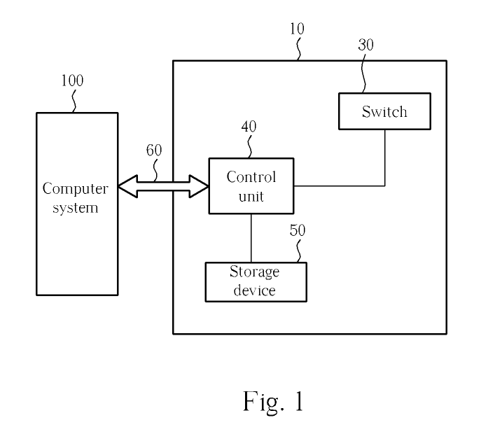

FIG. 1 is an illustration of a monitor 10 capable of controlling power and display parameters according to the present invention. The monitor 10 comprises a switch 30, a control unit 40, and a storage device 50. The monitor 10 further connects with a computer system 100 through a transmission channel 60 and is capable of receiving voltage signals and video signals from the computer system 100. When the computer system 100 is powered on, it transmits a PC5V voltage signal to the monitor 10 through the transmission channel 60. The control unit 40 of the monitor 10 recognizes the power on state of the computer system 100 by detecting the PC5V voltage signal.

Under the condition that the control unit 40 detects the presence of PC5V voltage signal, the control unit 40 can selectively set the monitor 10 in or out of an operative state, or a “power on” state. When the monitor 10 is turned on, the control unit 40 controls the monitor 10 to display video signals transmitted from the computer system 100 according to the display parameter stored in the storage device 50, in which the display parameter is parameter that determines the appearance of the screen such as the combination of brightness, contrast, H-size, H-position, V-size, V-position, trapezoid, pin-cushion, etc. When the monitor 10 is set out of the operative state, it is in a “standby” state: the monitor 40 is supplied with minor current by the control unit 40 but not displays any video signal, or a “power off” state: the control unit 40 supplies no current to the monitor 10. Practically, the switch 30 is installed on the monitor 10 in the form of a button and electrically connected with the control unit 40. According to the present invention, the control unit 40 is further capable of controlling the monitor 10 to display video signals received from the computer system 100 according to different display parameters based on the turn-on state of the switch 30.

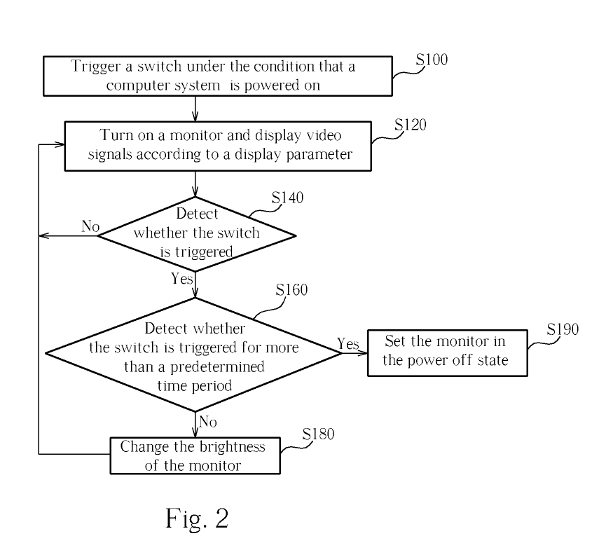

According to the aforementioned, the monitor 10 disclosed in the present invention controls the monitor 10 to display video signals according to different display parameters or turn the monitor 10 into on, off, or power saving states with single button according to different turn-on states of the switch 30. FIG. 2 is an illustration of a flow chart of a first exemplary embodiment of the method for controlling power and display parameter of a monitor 10. The first exemplary embodiment shows that when the monitor 10 is turned on, the method of the present invention changes the brightness of the monitor 10 by triggering the switch 30 for less than a predetermined time period or sets the monitor 10 in the power off state by triggering the switch 30 for more than the predetermined time period. The steps are as followed:

Step S100: Trigger the switch under the condition that the computer system 100 is powered on;

Step S120: The control unit 40 sets the monitor 10 on and controls the monitor 10 to display video signals received from the computer system 100 according to a display parameter;

Step S140: Detect whether the switch 30 is triggered; if the switch 30 is triggered, execute Step S160, or execute Step S120;

Step S160: Detect whether the switch 30 is triggered for more than the predetermined time period; if the triggered time exceeds the predetermined time period, execute Step S190;

Step S180: Change the brightness of the monitor 10 and execute Step S120;

Step S190: The control unit 40 sets the monitor 10 in the power off state.

When the computer system 100 is powered on, triggering the switch 30 (regardless of the triggering time) turns on the monitor 10 for displaying video signals received from the computer system 100 (Step S100, S120). The monitor 10 can display video signals according to a display parameter, which can be stored in the storage device 50 or transmitted from the computer system 100 once the monitor 10 is turned on (and then stored in the storage device 50). Under the condition that the computer system 100 and the monitor 10 are both powered on, if the switch 30 is pressed over a time period, i.e. the switch 30 is triggered for more than the predetermined time period, the control unit 40 powers off the monitor 10 or sets the monitor 10 in the standby state. In other word, the switch 30 (a button installed on the monitor 10 in the exemplary embodiment disclosed in the present invention) performs as a power control function on the monitor 10. When the switch 30 is pressed for less than a time period, i.e. the switch 30 is triggered for less than the predetermined time period, the control unit 40 changes the display parameter to which the monitor 10 displays video signals. In the exemplary embodiment of the present invention, the control unit 40 changes the brightness in the display parameter, and the monitor 10 displays video signals according to display parameters with different brightness (Step S180). In other word, the switch 30 has the function of changing brightness on the monitor 10.

Additionally, a plurality of parameters with different brightness is stored in the storage device 50. In Step S180, every time the switch 30 is triggered for less than the predetermined time period, the control unit 40 controls the monitor 10 to display video signals according to one display parameter stored in the storage device 50 successively. For example, The storage device 50 stores four display parameters, each with different brightness, which are practically configured for best working environments with word processing, gaming, movie, and web surfing. Each time the switch 30 is triggered, the control unit 40 controls the monitor 10 to display video signals according to one of the four display parameters with different brightness successively. When the monitor 10 is displaying video signals according to the last display parameter (web surfing) and when the switch 30 is triggered again, the method of the present invention changes the display parameters in loop, i.e. the control unit 40 controls the monitor 10 to display video signals according to the first display parameter (word processing).

In a second exemplary embodiment of the present invention, the control unit 40 changes the display parameter of the monitor 10 when the switch 30 is triggered for less than the predetermined time period as the first exemplary embodiment does but changes the display parameter by adding an adjustment value to the display parameter for the monitor 10 to display video signals. The adjustment value stores in the storage device 50 as the display parameter does. For example, the default display parameter stored in the storage device 50 has brightness 40, and the adjustment value is 20. When the switch 30 is triggered first time for less than the predetermined time period, the control unit 40 controls the monitor 10 to display video signals according to the display parameter with brightness 60 (the default display parameter 40 plus the adjustment value 20). When the switch 30 is triggered second time for less than the predetermined time period, the control unit 40 controls the monitor 10 to display video signals according to the display parameter with brightness 80. Triggering the switch 30 for less than the predetermined time period adds to the brightness of the monitor 10 in a row.

When the brightness of the monitor 10 reaches a maximum value (for example, 100), triggering the switch 30 again for less than the predetermined time period changes the brightness of the monitor 10 in loop in the second exemplary embodiment: the brightness in the display parameter decreases in sequence from the maximum 100 by 20 (100→80→60 . . . ), or the brightness alters back to 40 and increases in sequence by 20 (40→60→80 . . . ).

While the aforementioned exemplary embodiments change the brightness of the monitor 10 (displaying the video signals darker or brighter on the monitor 10), triggering the switch 30 for less than the predetermined time period in other exemplary embodiments of the present invention can change other display parameters such as contrast, hue, sharpness, etc. Besides, in Step S120, the monitor 10 displays video signals according to a display parameter only when the control unit 40 detects the presence of PC5V voltage signal to confirm that the computer system 100 is powered on and Step S140 is the next-step. If the control unit 40 can no longer detect the presence of PC5V signal, the control unit 40 changes the state of the monitor 10 according to whether the switch 30 is triggered or not. The control unit 40 sets the monitor 10 to the power off state when the switch 30 is triggered, or sets the monitor 10 to the standby state.

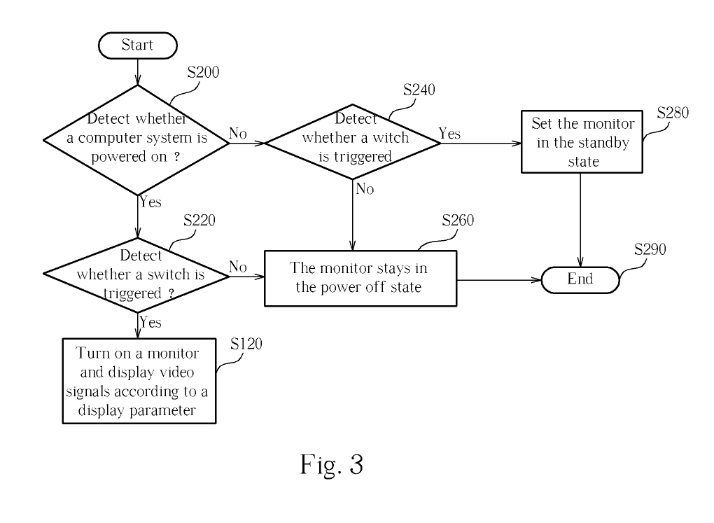

The flow chart in FIG. 2 is about the method for controlling the monitor 10 when the computer system 100 is powered on. Please refer to FIG. 3. When the computer system 100 is not in the powered on state, FIG. 3 further shows a flow chart of the method for controlling the power of the monitor 10 when the monitor 10 is not turned on according to different state of the switch 30. The steps are in the following:

Step S200: Detect whether the computer system 100 is powered on; if the computer system 100 is not powered on, execute Step S240;

Step S220: Detect whether the switch 30 is triggered (regardless of the triggering time); if the switch 30 is triggered, execute Step S120, otherwise execute Step S260;

Step S240: Detect whether the switch 30 is triggered (regardless of the triggering time); if the switch 30 is triggered, execute Step S280;

Step S260: The monitor 10 stays in the power off state and execute Step S290;

Step S280: The control unit 40 sets the monitor 10 in the standby state;

Step S290: End.

The method of the present invention discloses that under the condition of a computer system being powered on, a switch on a monitor controls the power or the display parameters of the monitor according to the triggering time of the switch. When the switch is triggered for more than a predetermined time period, a control unit of the monitor sets the monitor to the standby state or powers off the monitor. When the switch is triggered for less than the predetermined time period, the control device then controls the monitor to display video signals from the computer system according to different display parameters. The method and the monitor disclosed in the present invention can effectively deal with display abnormity of a monitor when the display parameter of the monitor corrupts or goes wrong, resulting in the situation that the monitor can no longer display a recognizable screen for necessary display parameter modification. With single button on the monitor, the present invention provides fast adjustability and display mode switching convenience.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for controlling a monitor, the monitor capable of being selectively set in or out of an operative state, the monitor having a switch and storing a first display parameter and a second display parameter, the method comprising steps of:
setting the monitor in the operative state for displaying a video signal according to the first display parameter;
the monitor displaying the video signal according to the second display parameter when detecting the switch being triggered for less than a predetermined time period; and
setting the monitor out of the operative state when detecting the switch being triggered for more than the predetermined time period.

2. The method of claim 1 wherein the monitor displaying the video signal brighter when the monitor displaying the video signal according to the second display parameter, and displaying the video signal darker when the monitor displaying the video signal according to the first display parameter.

3. The method of claim 1, further comprising step of:
the monitor displaying the video signal according to the first display parameter when the monitor is displaying the video signal according to the second display parameter and simultaneously detects the switch being triggered for less than the predetermined time period.

4. The method of claim 1 wherein the monitor is capable of detecting whether a computer system connected to the monitor is powered on, the monitor capable of being selectively set in an off state, a power-saving state, or the operative state, the method further comprising step of:
setting the monitor from the off state to the power-saving state when detecting the computer system not being powered on and the switch being simultaneously triggered.

5. The method of claim 1 wherein the monitor is capable of detecting whether a computer system connected to the monitor is powered on, the monitor capable of being selectively set in an off state, a power-saving state, or the operative state, the method further comprising step of:
setting the monitor from the off state or the power-saving state to the operative state when detecting the computer system being powered on and the switch being simultaneously triggered.

6. The method of claim 1 wherein the monitor is capable of detecting whether a computer system connected to the monitor is powered on, the monitor capable of being selectively set in an off state, a power-saving state, or the operative state, the method further comprising step of:
setting the monitor from the operative state to the off state when detecting the computer system being powered on and the switch being simultaneously triggered for more than the predetermined time period.

7. A method for controlling power and display parameters of a monitor capable of being selectively set in or out of an operative state, the monitor having a switch and storing a first display parameter and an adjustment value, the method comprising steps of:
setting the monitor in the operative state for displaying a video signal according to the first display parameter;
when the monitor detects the switch being triggered for less than a predetermined time period, generating a second display parameter by adding the adjustment value to the first display parameter and displaying the video signal according to the second display parameter; and
setting the monitor out of the operative state when detecting the switch being triggered for more than the predetermined time period.

8. The method of claim 7 wherein the difference between the second display parameter and the first display parameter adjusts either the brightness or the contrast of the video signal shown on the monitor.

9. The method of claim 7, further comprising steps of:
when the monitor displaying the video signal according to the second display parameter and simultaneously detecting the switch being triggered for less than the predetermined time period, generating a third display parameter by adding the adjustment to the second display parameter and displaying the video signal according to the third display parameter.

10. The method of claim 7 wherein the monitor is capable of detecting whether a computer system connected to the monitor is powered on, the monitor capable of being selectively set in an off state, a power-saving state, or the operative state, the method further comprising step of:
setting the monitor from the off state to the power-saving state when detecting the computer system not being powered on and simultaneously the switch being triggered.

11. The method of claim 7 wherein the monitor is capable of detecting whether a computer system connected to the monitor is powered on, the monitor capable of being selectively set in an off state, a power-saving state, or the operative state, the method further comprising step of:
setting the monitor from the off state or the power-saving state to the operative state when detecting the computer system being powered on and the switch being simultaneously triggered.

12. The method of claim 7 wherein the monitor is capable of detecting whether a computer system connected to the monitor is powered on, the monitor capable of being selectively set in an off state, a power-saving state, or the operative state, the method further comprising step of:
setting the monitor from the operative state to the off state when detecting the computer system being powered on and the switch being simultaneously triggered for more than the predetermined time period.

13. A monitor capable of being selectively set in or out of an operative state, comprising:
a storage device storing a first display parameter and a second display parameter, the monitor being capable of displaying a video signal selectively according to the first display parameter or to the second display parameter when in the operative state;
a switch capable of being selectively triggered; and
a control unit electrically coupled with the switch for detecting whether the switch is triggered;
wherein when the control unit detects the switch being triggered for less than a predetermined time period, the control unit controls the monitor from displaying the video signal according to the first display parameter to displaying the video signal according to the second display parameter;
wherein when the control unit detects the switch being triggered for more than the predetermined time period, the control unit sets the monitor out of the operative state.

14. The monitor of claim 13 wherein the control unit is for changing the brightness of the monitor when the switch is triggered for less than the predetermined time period, the monitor displaying the video signal with different brightness according to the second display parameter from displaying the video signal according to the first display parameter.

15. The monitor of claim 13 wherein the control unit is for controlling the monitor to display the video signal according to the first display parameter when the monitor is displaying the video signal according to the second display parameter and simultaneously detects the switch being triggered for less than the predetermined time period.

16. The monitor of claim 13 wherein the control unit is further for detecting whether a computer system connected to the monitor is powered on, the monitor capable of being selectively set in an off state, a power-saving state, or the operative state, the control unit setting the monitor from the off state to the power-saving state when detecting the computer system not being powered on and the switch being simultaneously triggered.

17. The monitor of claim 13 wherein the control unit is further for detecting whether a computer system connected to the monitor is powered on, the monitor capable of being selectively set in an off state, a power-saving state, or the operative state, the control unit setting the monitor from the off state or the power-saving state to the operative state when detecting the computer system being powered on and the switch being simultaneously triggered.

18. The monitor of claim 13 wherein the control unit is further for detecting whether a computer system connected to the monitor is powered on, the monitor capable of being selectively set in an off state, a power-saving state, or the operative state, the control unit setting the monitor from the operative state to the off state when detecting the computer system being powered on and the switch being simultaneously triggered for more than the predetermined time period.

19. A monitor capable of being selectively set in or out of an operative state, comprising:
a storage device storing a first display parameter and an adjustment value, the first display parameter being updated by adding the adjustment value to the first display parameter, the monitor being capable of displaying a video signal selectively according to the first display parameter or to the updated first display parameter when in the operative state;
a switch capable of being selectively triggered; and
a control unit electrically coupled with the switch for detecting whether the switch is triggered;
wherein when the control unit detects the switch being triggered for less than a predetermined time period, the control unit controls the monitor from displaying the video signal according to the first display parameter to displaying the video signal according to the updated first display parameter;
wherein when the control unit detects the switch being triggered for more than the predetermined time period, the control unit sets the monitor out of the operative state.

20. The monitor of claim 19 wherein the control unit is for controlling the monitor to further increase the updated first display parameter by adding the adjustment value once when the monitor is displaying the video signal and simultaneously detecting the switch being triggered for less than the predetermined time period.

21. The monitor of claim 19 wherein when the sum of the updated first display parameter and the adjustment value is more than a maximum value, then the control unit updates the updated first display parameter back to the first display parameter, so allowing for changing the display parameters in loop.
